(19) United States
(12) Patent Application Publication
(10) Pub. No.: US 2013/0048483 A1
(43) Pub. Date: Feb. 28, 2013

(54) M-BLADE SNAP ACTION SWITCH WITH OPTIMAL SWITCH CONTACT FORCES

(71) Applicants: Brian Speldrich, Freeport, IL (US); Steven Speece, Winnebago, IL (US); Mark Green, Asheville, NC (US)

(72) Inventors: Brian Speldrich, Freeport, IL (US); Steven Speece, Winnebago, IL (US); Mark Green, Asheville, NC (US)

(73) Assignee: HONEYWELL INTERNATIONAL INC., Morristown, NJ (US)

(21) Appl. No.: 13/219,033

(22) Filed: Aug. 26, 2011

(51) Int. Cl. H01H 5/00

(52) U.S. Cl. 200/468

(57) ABSTRACT

A snap-action switch includes an M-blade snap spring, an actuation arm, a first bridge, and a second bridge. The M-blade snap spring includes a closed end, a double-loop end, a first outer leg, a second outer leg, a first inner leg, a second inner leg, and a cross member. The actuation arm is coupled to the first and second inner legs, and distorts the M-blade snap to exhibit snap-action movement between a first switch position and a second switch position. When the M-blade snap spring is in the first switch position, the double-loop end engages the first bridge and does not engage the second bridge, and when the M-blade snap spring is in the second switch position, the double-loop end engages the second bridge and does not engage the first bridge.

### TECHNICAL FIELD

The present invention generally relates to snap-action switches, and more particularly relates to an M-blade snap-action switch that is configured to exhibit optimal switch contact forces.

### BACKGROUND

Electrical switches typically operate to open and close an electrical circuit by moving one or more contacts between contact positions. One particular type of electrical switch is a snap-action switch. A snap action switch includes a snap spring, or some other type of mechanism, that very rapidly moves the switch contacts from one position to another. Various types of snap springs have been developed over the years. One particular type of snap spring is the M-blade snap spring. The M-blade exhibits certain advantages over other known snap springs. These advantages include its relative ease of manufacture, its controllability, and it characteristic of increasing contact force up to the moment of snap.

Notwithstanding the above-mentioned advantages, snap action switches that include M-blade snap springs can suffer certain drawbacks. In particular, these switches can exhibit less than optimum contact force-versus-displacement characteristics and/or relatively poor fatigue life. Hence, there is a need for an M-blade snap action switch that exhibits more optimal contact force-versus-displacement characteristics and relatively longer fatigue life. The present invention addresses at least these needs.

### BRIEF SUMMARY

In one embodiment, a snap action switch includes an M-blade snap spring, an actuation arm, a first bridge, and a second bridge. The M-blade snap spring includes a closed end, a double-loop end, a first outer leg, a second outer leg, a first inner leg, a second inner leg, and a cross member. The double-loop end is disposed opposite the closed end and includes a first loop and a second loop. The first outer leg is coupled to the first inner leg to form the first loop of the double-loop end, the second outer leg is coupled to the second inner leg to form the second loop of the double-loop end. The cross member is coupled to the first outer leg and to the second outer leg to define the closed end. The first inner leg is spaced apart from the second inner leg. The actuation arm is coupled to, and includes a portion that extends between, the first and second inner legs, and is dimensioned to distort the M-blade snap spring such that the first and second inner legs are out of coplanar alignment with the first and second outer legs and the cross member, whereby the M-blade snap spring exhibits snap-action movement between a first switch position and a second switch position. The first bridge is disposed adjacent a first side of the double-loop end, and the second bridge is disposed adjacent a second side of the double-loop end. The actuation arm is configured to selectively move the first and second inner legs between a first inner leg position and a second inner leg position, to thereby cause the M-blade snap spring to move, via snap action, between the first switch position and the second switch position, respectively. When the M-blade snap spring is in the first switch position, the double-loop end engages the first bridge and does not engage the second bridge, and when the M-blade snap spring is in the second switch position, the double-loop end engages the second bridge and does not engage the first bridge.

In another embodiment, a snap action switch includes a housing, a first bridge, a second bridge, and an M-blade snap spring, and an actuation arm. The first bridge is coupled to the housing, and the second bridge is coupled to the housing and is spaced apart from the first bridge. The M-blade snap spring is disposed within the housing, and includes a closed end, a double-loop end, a first outer leg, a second outer leg, a first inner leg, a second inner leg, and a cross member. The double-loop is end disposed opposite the closed end and between the first bridge and the second bridge, and includes a first loop and a second loop. The first outer leg is coupled to the first inner leg to form the first loop of the double-loop end, and the second outer leg coupled to the second inner leg to form the second loop of the double-loop end. The cross member is coupled to the first outer leg and to the second outer leg to define the closed end. The first inner leg is spaced apart from the second inner leg. The actuation arm is coupled to the housing and the first and second inner legs, and includes a portion that extends between the first and second inner legs, and is dimensioned to distort the M-blade snap spring such that the first and second inner legs are out of coplanar alignment with the first and second outer legs and the cross member, whereby the M-blade snap spring exhibits snap-action movement between a first switch position and a second switch position. The actuation arm is configured to selectively move the first and second inner legs between a first inner leg position and a second inner leg position, to thereby cause the M-blade snap spring to move, via snap action, between the first switch position and the second switch position, respectively. When the M-blade snap spring is in the first switch position, the double-loop end engages the first bridge and does not engage the second bridge, and when the M-blade snap spring is in the second switch position, the double-loop end engages the second bridge and does not engage the first bridge.

In yet another embodiment, a snap action switch includes a housing, a first bridge, a second bridge, an M-blade snap spring, an actuation arm, an actuator, a normally-closed contact, and a normally-open contact. The first bridge is coupled to the housing, and the second bridge is coupled to the housing and is spaced apart from the first bridge. The M-blade snap spring is disposed within the housing, and includes a closed end, a double-loop end, a first outer leg, a second outer leg, a first inner leg, a second inner leg, and a cross member. The double-loop is end disposed opposite the closed end and between the first bridge and the second bridge, and includes a first loop and a second loop. The first outer leg is coupled to the first inner leg to form the first loop of the double-loop end, and the second outer leg coupled to the second inner leg to form the second loop of the double-loop end. The cross member is coupled to the first outer leg and to the second outer leg to define the closed end. The first inner leg is spaced apart from the second inner leg. The actuation arm is coupled to the housing and the first and second inner legs, and includes a portion that extends between the first and second inner legs, and is dimensioned to distort the M-blade snap spring such that the first and second inner legs are out of coplanar alignment with the first and second outer legs and the cross member, whereby the M-blade snap spring exhibits snap-action movement between a first switch position and a second switch position. The actuation arm is coupled to the housing and the first and second inner legs, and includes a portion that extends between the first and second inner legs and that is dimensioned to distort the M-blade snap spring such that the first and second inner legs are out of coplanar alignment with the first and second outer legs and the cross member, whereby the M-blade snap spring exhibits snap-action movement between a first switch position and a second switch position. The actuator extends through the housing and is disposed adjacent the actuation arm. The actuator is configured to selectively supply an actuation force to, and remove an actuation force from, the actuation arm, and thereby selectively move the M-blade snap spring, via snap-action, between the first switch position and the second switch position, respectively. The normally-closed contact is coupled to the housing, and the normally-open contact is coupled to the housing and spaced apart from the normally-closed contact. When the M-blade snap spring is in the first switch position, the M-blade snap spring is electrically connected to the normally-closed contact, and the double-loop end engages the first bridge and does not engage the second bridge, and when the M-blade snap spring is in the second switch position, the M-blade snap spring is electrically connected to the normally-open contact, and the double-loop end engages the second bridge and does not engage the first bridge.

Furthermore, other desirable features and characteristics of the snap action switch will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIGS. 1 and 2 are cross-section views of one embodiment of an M-blade snap-action switch in a first switch position and a second switch position, respectively;

FIG. 3 is a plan view of an M-blade that may be used to implement the snap-action switch depicted in FIGS. 1 and 2;

FIG. 4 is a graph depicting contact forces and plunger force for the snap-action switch depicted in FIGS. 1 and 2;

FIG. 5 is a graph depicting contact forces and plunger force for a snap-action switch similar to the one depicted in FIGS. 1 and 2, but with no bridges; and

FIG. 6 is a graph depicting contact forces and plunger force for a snap-action switch similar to the one depicted in FIGS. 1 and 2, but with only a single bridge.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

In this document, relational terms such as first and second, and the like may be used solely to distinguish one entity or action from another entity or action without necessarily requiring or implying any actual such relationship or order between such entities or actions. Moreover, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements. Furthermore, there is no intention to be bound by any expressed or implied theory presented in the preceding technical field, background, brief summary, or the following detailed description.

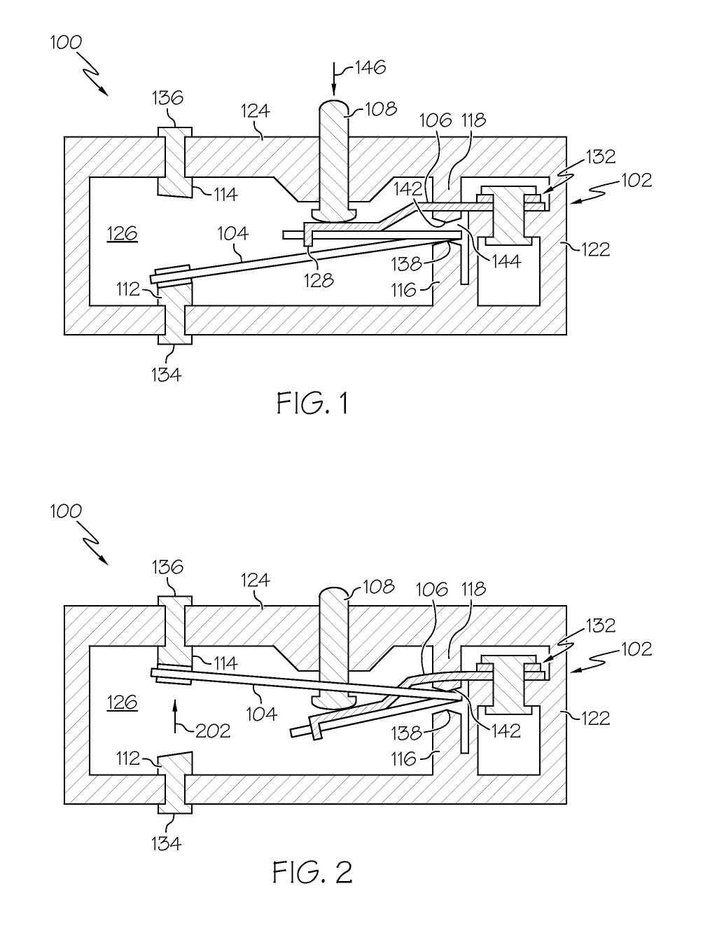

Referring now to FIG. 1, a cross section view of one exemplary embodiment of a snap-action switch 100 is depicted and includes a housing 102, an M-blade snap spring 104, an actuation arm 106, an actuator 108, a normally-closed contact 112, a normally-open contact 114, first bridge 116, and a second bridge 118. The housing 102 may be variously configured and implemented, but the depicted housing 102 includes a mount structure 122 and a cover 124. The mount structure 122, as will be described herein below, is used to mount various ones of the switch components, and together with the cover 124 defines a cavity 126 within which the switch components are disposed.

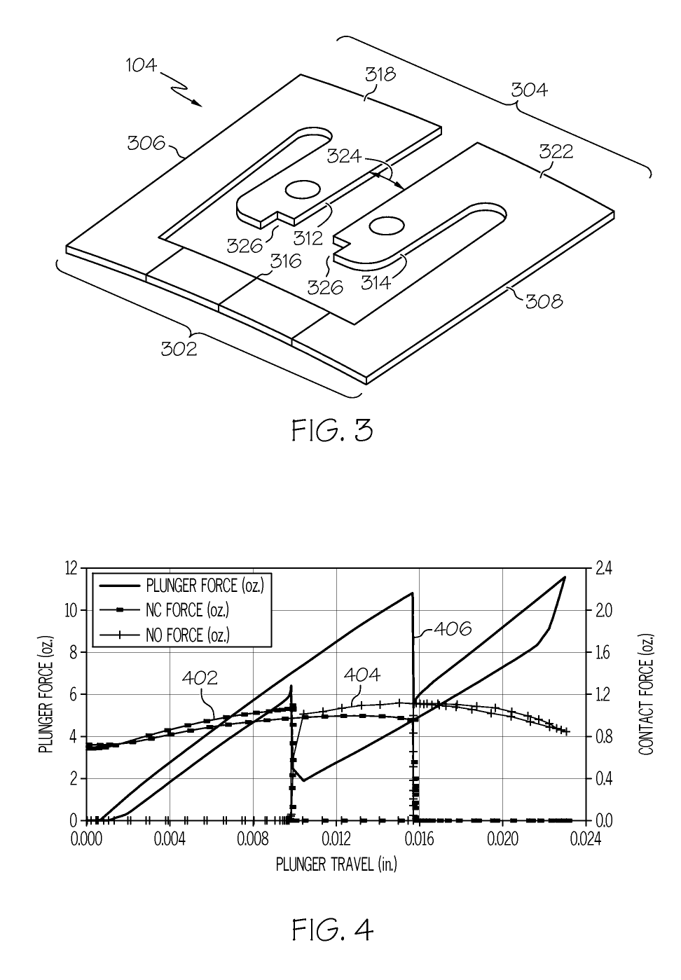

The M-blade snap spring 104 is disposed within the housing 102 and is configured to exhibit snap-action movement between a first switch position, which is the position depicted in FIG. 1, and a second switch position, which is the position depicted in FIG. 2. The M-blade snap spring 104 may be variously configured and implemented. One particular configuration and implementation of the M-blade snap spring 104 is depicted in FIG. 3, and will now be described.

The depicted M-blade snap spring 104 includes a closed end 302, a double-loop end 304, a first outer leg 306, a second outer leg 308, a first inner leg 312, a second inner leg 314, and a cross member 316. The double-loop end 304 is disposed opposite the closed end 302 and includes a first loop 318 and a second loop 322. The first outer leg 306 is coupled to the first inner leg 312 to form the first loop 318 of the double-loop end 304. The second outer leg 308 is coupled to the second inner leg 314 to form the second loop 322 of the double-loop end 304. The cross member 316 is coupled to the first outer leg 306 and to the second outer leg 308 to define the closed end 302.

As FIG. 3 also depicts, the first inner leg 312 is spaced apart from the second inner leg 314 to define a gap 324. When the first and second inner legs 312, 314 are spread further apart to increase the width of the gap 324, the M-blade snap spring 104 is distorted, such that the first and second inner legs 312, 314 are out of coplanar alignment with the first and second outer legs 306, 308 and the cross member 316. As a result, the M-blade snap spring 104 exhibits snap-action movement between the first switch position and the second switch position.

In the depicted embodiment, the first and second legs 312, 314 are spread via the actuation arm 106. In particular, the first and second legs 312, 314 each have a locating recess 326 formed in an end thereof, and into which a portion 128 (see FIGS. 1 and 2) of the actuation arm 106 is inserted. This portion 128, which in the depicted embodiment is implemented as a tab that is formed integrally with the actuation arm 106, is dimensioned to spread the first and second inner legs 312, 314 and distort the M-blade snap spring 104, as described above. It will be appreciated that the portion 128 of the actuation arm 106 that is used to distort the M-blade snap spring 104 may be variously implemented and configured, and may be implemented integrally with the actuation arm 106, or implemented separate from the actuation arm 106 and then coupled thereto.

Returning to FIGS. 1 and 2, it is seen that the actuation arm 106, in addition to being coupled to the first and second inner legs 312, 314, is coupled to the housing 102, and more specifically the mount structure 122. In the depicted embodiment, the actuation arm 106 is coupled at its one end to the mount structure 122 via suitable mount hardware 132, and is coupled at its other end to the first and second inner legs 312, 314 via suitable fastener hardware, welding, brazing, or soldering. It will be appreciated that the actuation arm 106 may be variously configured and implemented. o matter its specific configuration, or the specific manner in which it is coupled to the housing 102 and the first and second inner legs 312, 314, the actuation arm 106 is additionally configured to receive an actuation force from the actuator 108.

The actuator 108 extends through the housing 102 and is disposed adjacent to the actuation arm 106. The actuator 108 is configured to selectively supply an actuation force to, and remove an actuation force from, the actuation arm 106, to thereby selectively move the M-blade snap spring 104, via snap-action, between the first switch position and the second switch position, respectively. Although the actuator may be variously configured to implement this functionality, in the depicted embodiment it is implemented using a plunger-type device that extends through the cover 124, and contacts the actuation arm 106. The depicted actuator 108 may receive an input force from a non-illustrated external device, such as a motor or solenoid, for example, or it may receive an input force from a user.

As noted above, the snap-action switch 100 additionally includes a normally-closed contact 112, a normally-open contact 112, a first bridge 116, and a second bridge 118. The normally-closed contact 112 is coupled to, and extends through, the housing 102 to a first terminal 134, which allows the normally-closed contact 112 to be electrically connected to external devices, circuits, or systems. The normally-open contact 114 is spaced apart from the normally-closed contact 112. The normally-open contact 114 is also coupled to, and extends through, the housing 102 to a second terminal 136, which allows the normally-open contact 114 to be electrically connected to external devices, circuits, or systems.

The first bridge 116 and the second bridge 118 are both coupled to the housing 102, and extend into the cavity 126. In the depicted embodiment, the first bridge 116 is coupled to the mount structure 122 and extends into the cavity to a first engagement end 138, and the second bridge 118 is coupled to the cover 124 and extends into the cavity 126 to a second engagement end 142. The first and second engagement ends 138, 142 are spaced apart from each other to form a space 144, and are located such that the double-loop end 304 of the M-blade snap spring 104 is disposed in the space 144 between the first and second bridges 114, 116. As will be described further below, with this configuration, the double-loop end 304 of the M-blade snap spring 104 selectively engages either the first bridge 114 or the second bridge 116, depending upon the position of the M-blade snap spring 104.

It will be appreciated that the first and second bridges 116, 118 may be variously configured and implemented to carry out the above-described functions. In the depicted embodiment, the first bridge 116 is formed as an integral part of the mount structure 122, and the second bridge 116 is formed as an integral part of the cover 124. It will be appreciated, however, that in other embodiments one or both of the first and second bridges 116, 118 may be implemented as separate devices and mounted within, or otherwise coupled to, the housing 102.

Having described the structure of the snap-action switch 100, and generally described certain functions of the various components that comprise the snap-action switch 100, its overall operation will now be described. The “normal” state of the snap-action switch 100 is depicted FIG. 1, when no (or insufficient) force is being supplied to the actuator 108. In this state, the first and second inner legs 312, 314 are in a first inner leg position, and the M-blade snap spring 104 is in the first switch position, in which it is electrically connected to the normally-closed contact 112. Additionally, the double-loop end 304 of the M-blade snap spring 104 engages the first bridge 116, and does not engage the second bridge 118.

When a force of sufficient magnitude is supplied to the actuator 108 in a first direction 146, it pushes against the actuator arm 106, and thus causes the first and second inner legs 312, 314 of the M-blade snap spring 104 to also move in the first direction 146. When the first and second inner legs 312, 314 reach a first point, which may be referred to as the “operate point” or snap-over point,” the first and second outer legs 306, 308 snap in a second direction 202 (see FIG. 2), and place the M-blade snap spring 104 in the second switch position. The first and second inner legs 312, 314 may continue to travel to the second inner leg position depicted in FIG. 2. In the second switch position, the M-blade snap spring 104 is electrically connected to the normally-open contact 114. Moreover, the double-loop end 304 of the M-blade snap spring 104 now engages the second bridge 118, and does not engage the first bridge 116.

Thereafter, upon removal of the force from the actuator 108, the first and second inner legs 312, 314 of the M-blade snap spring 104 will move in the second direction 202. When the first and second inner legs 312, 314 reach a second point, which may be referred to as the “return point,” the first and second outer legs 306, 308 snap back in the first direction 146, and place the M-blade snap spring 104 back into the first switch position.

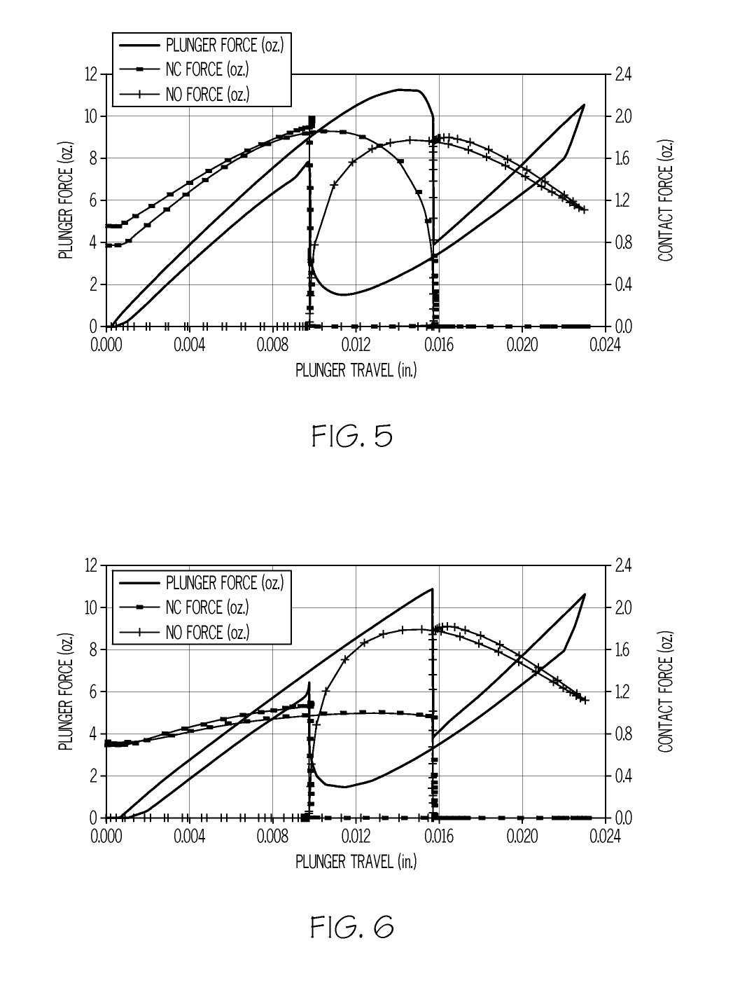

Including the first and second bridges 116, 118 in the snap-action switch 100 improves contact force performance. In particular, the first and second bridges 116, 118 increase (or maintain) contact force throughout the stroke of the actuator 108; that is, up until the M-blade spring 104 snaps at either the operate point or the return point. The first and second bridges 116, 118 also sharpen the plunger force. These improvements are shown graphically in FIGS. 4-6. In particular, FIG. 4 depicts the contact forces 402, 404 and the plunger force 406 throughout the stroke of the actuator 108 for one embodiment of the snap-action switch 100 described herein. The graph depicted in FIG. 4 shows marked improvements over previously known M-blade snap-action switches, which may include no bridges (FIG. 5) or may include only the first bridge 116 (FIG. 6). The fatigue life of the snap-action switch 100 is also improved.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A snap-action switch, comprising:
an M-blade snap spring including a closed end, a double-loop end, a first outer leg, a second outer leg, a first inner leg, a second inner leg, and a cross member, the double-loop end disposed opposite the closed end and including a first loop and a second loop, the first outer leg coupled to the first inner leg to form the first loop of the double-loop end, the second outer leg coupled to the second inner leg to form the second loop of the double-loop end, the cross member coupled to the first outer leg and to the second outer leg to define the closed end, the first inner leg spaced apart from the second inner leg;
an actuation arm coupled to, and including a portion that extends between, the first and second inner legs, the portion dimensioned to distort the M-blade snap spring such that the first and second inner legs are out of coplanar alignment with the first and second outer legs and the cross member, whereby the M-blade snap spring exhibits snap-action movement between a first switch position and a second switch position;
a first bridge disposed adjacent a first side of the double-loop end; and
a second bridge disposed adjacent a second side of the double-loop end,
wherein:
the actuation arm is configured to selectively move the first and second inner legs between a first inner leg position and a second inner leg position, to thereby cause the M-blade snap spring to move, via snap action, between the first switch position and the second switch position, respectively,
when the M-blade snap spring is in the first switch position, the double-loop end engages the first bridge and does not engage the second bridge, and
when the M-blade snap spring is in the second switch position, the double-loop end engages the second bridge and does not engage the first bridge.

2. The switch of claim 1, further comprising:
a normally-closed contact disposed to be electrically connected to the M-blade snap spring when the M-blade snap spring is in the first switch position; and
a normally-open contact spaced apart from the normally-closed contact, and disposed to be electrically connected to the M-blade snap spring when the M-blade snap spring is in the first switch position.

3. The switch of claim 1, further comprising:
an actuator disposed adjacent the actuation arm and configured to selectively supply an actuation force to, and remove an actuation force from, the actuation arm.

4. The switch of claim 1, wherein the M-blade snap spring is made from sheet metal.

5. The switch of claim 1, wherein the portion of the actuation arm that extends between the first and second inner legs comprises a structure that extends from and protrudes between the first and second inner legs.

6. The switch of claim 1, further comprising:
a mount structure having the actuation arm, the first bridge, and the second bridge coupled thereto.

7. The switch of claim 6, further comprising:
a switch housing having the mount structure, the M-blade snap spring, the actuation arm, the first bridge, and the second bridge disposed therein.

8. A snap-action switch, comprising:
a housing;
a first bridge coupled to the housing;
a second bridge coupled to the housing and spaced apart from the first bridge;
an M-blade snap spring disposed within the housing, the M-blade snap spring including a closed end, a double-loop end, a first outer leg, a second outer leg, a first inner leg, a second inner leg, and a cross member, the double-loop end disposed opposite the closed end and between the first bridge and the second bridge, the double-loop end including a first loop and a second loop, the first outer leg coupled to the first inner leg to form the first loop of the double-loop end, the second outer leg coupled to the second inner leg to form the second loop of the double-loop end, the cross member coupled to the first outer leg and to the second outer leg to define the closed end, the first inner leg spaced apart from the second inner leg; and
an actuation arm coupled to the housing and the first and second inner legs, and including a portion that extends between the first and second inner legs, the portion dimensioned to distort the M-blade snap spring such that the first and second inner legs are out of coplanar alignment with the first and second outer legs and the cross member, whereby the M-blade snap spring exhibits snap-action movement between a first switch position and a second switch position;
wherein:
the actuation arm is configured to selectively move the first and second inner legs between a first inner leg position and a second inner leg position, to thereby cause the M-blade snap spring to move, via snap action, between the first switch position and the second switch position, respectively,
when the M-blade snap spring is in the first switch position, the double-loop end engages the first bridge and does not engage the second bridge, and
when the M-blade snap spring is in the second switch position, the double-loop end engages the second bridge and does not engage the first bridge.

9. The switch of claim 8, further comprising:
a normally-closed contact coupled to the housing and disposed to be electrically connected to the M-blade snap spring when the M-blade snap spring is in the first switch position; and
a normally-open contact coupled to the housing and spaced apart from the normally-closed contact, the normally-open contact disposed to be electrically connected to the M-blade snap spring when the M-blade snap spring is in the first switch position.

10. The switch of claim 8, further comprising:
an actuator extending through the housing and disposed adjacent the actuation arm, the actuator configured to selectively supply an actuation force to, and remove an actuation force from, the actuation arm.

11. The switch of claim 8, wherein the M-blade snap spring is made from sheet metal.

12. The switch of claim 8, wherein the portion of the actuation arm that extends between the first and second inner legs comprises a structure that extends from and protrudes between the first and second inner legs.

13. The switch of claim 8, further comprising:
a mount structure having the actuation arm, the first bridge, and the second bridge coupled thereto.

14. A snap-action switch, comprising:
a housing;
a first bridge coupled to the housing;
a second bridge coupled to the housing and spaced apart from the first bridge;
an M-blade snap spring disposed within the housing, the M-blade snap spring including a closed end, a double-loop end, a first outer leg, a second outer leg, a first inner leg, a second inner leg, and a cross member, the double-loop end disposed opposite the closed end and between the first bridge and the second bridge, the double-loop end including a first loop and a second loop, the first outer leg coupled to the first inner leg to form the first loop of the double-loop end, the second outer leg coupled to the second inner leg to form the second loop of the double-loop end, the cross member coupled to the first outer leg and to the second outer leg to define the closed end, the first inner leg spaced apart from the second inner leg;
an actuation arm coupled to the housing and the first and second inner legs, and including a portion that extends between the first and second inner legs, the portion dimensioned to distort the M-blade snap spring such that the first and second inner legs are out of coplanar alignment with the first and second outer legs and the cross member, whereby the M-blade snap spring exhibits snap-action movement between a first switch position and a second switch position;
an actuator extending through the housing and disposed adjacent the actuation arm, the actuator configured to selectively supply an actuation force to, and remove an actuation force from, the actuation arm, and thereby selectively move the M-blade snap spring, via snap-action, between the first switch position and the second switch position, respectively;
a normally-closed contact coupled to the housing; and
a normally-open contact coupled to the housing and spaced apart from the normally-closed contact,
wherein:
when the M-blade snap spring is in the first switch position, the M-blade snap spring is electrically connected to the normally-closed contact, and the double-loop end engages the first bridge and does not engage the second bridge, and
when the M-blade snap spring is in the second switch position, the M-blade snap spring is electrically connected to the normally-open contact, and the double-loop end engages the second bridge and does not engage the first bridge.

15. The switch of claim 14, wherein the M-blade snap spring is made from sheet metal.

16. The switch of claim 14, wherein the portion of the actuation arm that extends between the first and second inner legs comprises a structure that extends from and protrudes between the first and second inner legs.

17. The switch of claim 14, further comprising:
a mount structure having the actuation arm, the first bridge, and the second bridge coupled thereto.
